(19) United States
(12) Patent Application Publication
(10) Pub. No.: US 2010/0080917 A1
(43) Pub. Date: Apr. 1, 2010

(54) POROUS MATERIAL PRODUCTION METHOD

(75) Inventors: Hidekazu Yamazaki, Minami-ashigara-shi (JP); Tsukasa Ishihara, Minami-ashigara-shi (JP); Koju Ito, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/569,676

(22) Filed: Sep. 29, 2009

(30) Foreign Application Priority Data
Sep. 30, 2008 (JP) 2008-254603

(51) Int. Cl. B05D 5/00; B05D 3/00

(52) U.S. Cl. 427/299; 427/373

(57) ABSTRACT

A solution containing a polymer and a solvent is discharged onto a surface of a polymer film to form a coating film. When a thickness of the coating film is a critical thickness or less, dewetting of the solution occurs on the surface, and the coating film becomes a dewetting material having dewetting pores. Wet air is blown to a surface of the dewetting material. The solvent is evaporated from the dewetting material. Water vapor is condensed from ambient air on the surface of the dewetting material to generate water drops. Dry air is blown to the surface of the dewetting material. The solvent and the water drops are evaporated from the dewetting material. Thereby, it is possible to produce a porous material whose surface includes first pores as the dewetting pores formed by the dewetting of the solution and the second pores formed by the water drops as a template for the porous material.

### FIELD OF THE INVENTION

The present invention relates to a porous material production method.

### BACKGROUND OF THE INVENTION

Conventionally, various attempts to form fine microasperities on a surface of various kinds of materials have been made. For example, Japanese Patent Laid-Open Publication No. 7-197017 discloses methods for forming fine microasperities on a surface of various kinds of materials by a machining processing, an electrical processing, a chemical processing, and the like. The machining processing includes cutting, grounding, and electrochemical machining. The electrical processing includes electroplating and laser processing. The chemical processing includes electrolysis, chemical reaction, microbial reaction, and diffusion limited aggregation (DLA). In addition to the above processings, there are vacuum deposition, lithography, ion beam processing, and plasma processing. The above processings may be combined together. Further, according to Japanese Patent Laid-Open Publication No. 7-197017, periodically arranged microasperities significantly develop a water-repellant property of the material. Furthermore, the microasperities constitute a multiple-stage periodic structure including a large periodic structure and a short periodic structure. A waveform of the short periodic structure is overlapped with a waveform of the large periodic structure. Thereby, it is possible to exert extremely excellent water-repellent property on the surface of the material.

However, the method disclosed in Japanese Patent Laid-Open Publication No. 7-197017 has the following problems. Although the multiple-stage periodic structure of microasperities can be formed on the surface of the material, the above processings are laborious. Further, in order to develop the water-repellent property on the surface of the material, it is necessary to form the multiple-stage periodic structure of microasperities on the surface of the material, and therefore processing accuracy at a certain level is required. However, in a case where a processing method having high accuracy is utilized, as disclosed in Japanese Patent Laid-Open Publication No. 7-197017, the scale of processing equipment becomes large. However, in a case where small-scale processing equipment is adopted, high accuracy cannot be obtained.

### SUMMARY OF THE INVENTION

In view of the above, an object of the present invention is to provide a porous material production method capable of readily producing a porous material having a multiple-stage periodic structure of microasperities.

In order to achieve the above and other objects, a porous material production method of the present invention includes a coating step, a dewetting step, a water drop generating step, a solvent evaporating step, and a water drop evaporating step. In the coating step, a solution containing a polymer and a hydrophobic solvent is applied to a surface of a base material. In the dewetting step, dewetting of the solution is caused on the surface. In the water drop generating step, water drops are generated on a liquid surface of the solution. In the solvent evaporating step, the hydrophobic solvent is evaporated from the solution on the surface to form a primary form into which the water drops enter. In the water drop evaporating step, the water drops are evaporated from the primary form to form pores in the primary form. The pores are made by the water drops as a template for the porous material.

In the coating step, a coating thickness of the solution is preferably a critical thickness at which the dewetting of the solution starts on the surface or less. It is preferable that a coating thickness of the solution is thicker than a critical thickness at which the dewetting of the solution starts on the surface in the coating step and the hydrophobic solvent is evaporated from the solution until the coating thickness of the solution becomes the critical thickness or less in the dewetting step.

The dewetting step may be performed either before or after the water drop generating step. A contact angle of the solution to the surface is preferably at least 5°. Further, it is preferable that the surface is subjected to a pretreatment for processing the surface before the coating step such that the contact angle of the solution to the surface becomes at least 5°.

According to the present invention, it is possible to produce the porous material having periodically arranged microasperities more readily in comparison with the conventional methods, because the dewetting material includes the first pores formed by the dewetting of the solution and arranged at a first periodic distance, and the second pores formed by the water drops as a template for the porous material and arranged at a second periodic distance smaller than the first periodic distance.

### DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is an explanatory view illustrating a porous material production procedure;

FIG. 2 is an explanatory view schematically illustrating a porous material production apparatus;

FIG. 3 is a perspective view schematically illustrating a first area;

FIG. 4A is an enlarged view illustrating a part of a surface of a coating film, which is surrounded by a chain double-dashed line IV of FIG. 3, and FIG. 4B is a cross sectional view taken along chain double-dashed lines b-b of FIG. 4A;

FIG. 5A is an enlarged view illustrating a part of a surface of a dewetting material, which is surrounded by a chain double-dashed line V of FIG. 3, and FIG. 5B is a cross sectional view taken along chain double-dashed lines b-b of FIG. 5A;

FIGS. 6A to 6D are respectively enlarged views illustrating a portion surrounded by a chain double-dashed line VI of FIG. 5B, wherein FIG. 6A explanatorily illustrates a state in which wet air is blown to a surface of the dewetting material in a condensation step, FIG. 6B explanatorily illustrates a state in which a solvent is evaporated from the dewetting material due to the contact of the wet air with the dewetting material, to generate water drops on the surface of the dewetting material, FIG. 6C explanatorily illustrates a state in which the solvent is evaporated from the dewetting material, and the water drops generated on the surface of the dewetting material enter the inside of the dewetting material while growing up, and FIG. 6D explanatorily illustrates a state in which the water drops are evaporated from the dewetting material due to the contact of dry air with the dewetting material;

FIG. 7A is a plan view schematically illustrating a porous material, FIG. 7B is an enlarged view of a portion surrounded by a chain double-dashed line b of FIG. 7A, and FIG. 7C is a cross sectional view taken along solid lines c-c of FIG. 7B;

FIG. 8A is a plan view of an enlarged main portion of the porous material according to an embodiment of the present invention, FIG. 8B is a cross sectional view taken along solid lines b-b of FIG. 8A, FIG. 8C is a cross sectional view taken along solid lines c-c of FIG. 8A, and FIG. 8D is across sectional view of a porous material according to another embodiment of the present invention;

FIG. 9A is a plan view schematically illustrating a dewetting material having dimples as first pores formed on the surface, FIG. 9B is a plan view schematically illustrating a dewetting material in which the first pores of FIG. 9A grow up to be through holes, FIG. 9C is a plan view schematically illustrating a dewetting material in which the first pores of FIG. 9B further grow up to be larger, FIG. 9D is a plan view schematically illustrating a dewetting material in which the first pores of FIG. 9C still further grow up;

FIG. 10A is across sectional view taken along solid lines XA-XA of FIG. 9A, FIG. 10B is a cross sectional view taken along solid lines XB-XB of FIG. 9B, FIG. 10C is a cross sectional view taken along solid lines XC-XC of FIG. 9C, and FIG. 10D is a cross sectional view taken along solid lines XD-XD of FIG. 9D; and

FIG. 11 is an explanatory view illustrating a contact angle of a solution to a surface of a base material.

### DESCRIPTION OF THE PREFERRED EMBODIMENTS

Hereinafter, preferred embodiments of the present invention are described in detail. However, the present invention is not limited thereto.

(Porous Material Production Procedure)

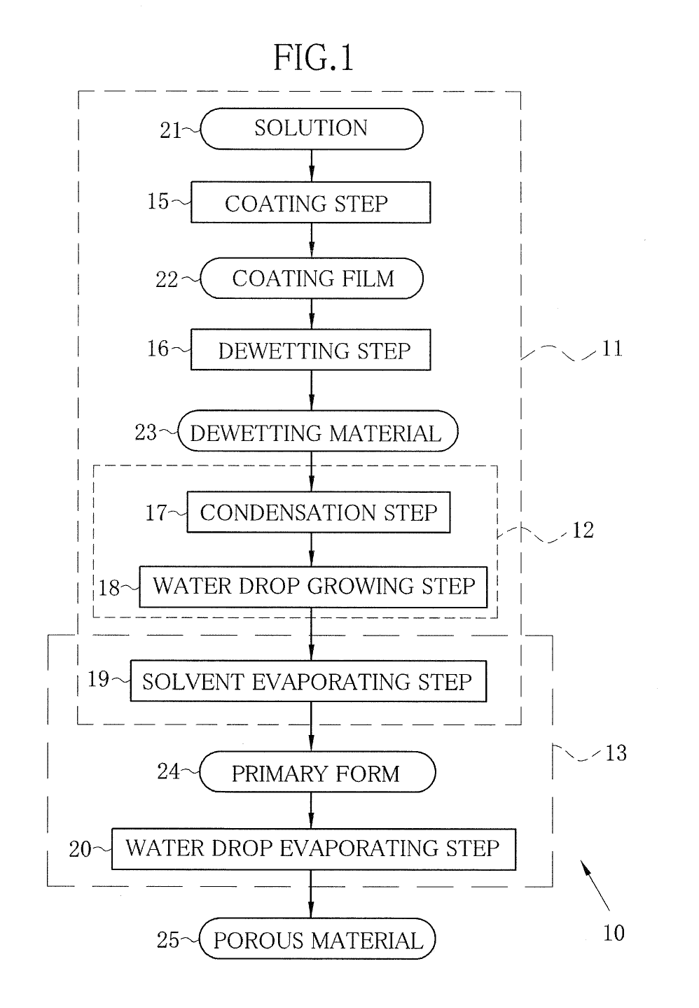

As shown in FIG. 1, a porous material production procedure 10 includes a coating step 15, a dewetting step 16, a condensation step 17, a water drop growing step 18, a solvent evaporating step 19, and a water drop evaporating step 20.

In the coating step 15, a solution 21 is applied to a base material described later to form a coating film 22 on the base material. In a case where a thickness of the coating film 22 formed from the solution 21 is a critical thickness THc or less, dewetting of the coating film 22 occurs on the base material. Since the coating film 22 is formed from the solution 21, dewetting of the coating film 22 means dewetting of the solution 21 on the surface of the base material. The dewetting of the coating film arises from fluctuation in thickness of the coating film. A part of the solution on the base material or the coating film, which is unstable in view of the energy, is ruptured, and thereby the dewetting of the coating film occurs. “Rupture of the coating film” means not aggregation of solutions 21 which are repelled on the base material but division of the coating film 22 into plural coating films 22 on the base material. Thereby, the thickness of each of the coating films 22 after being divided is larger than that of the coating film 22 before being divided. Upon the dewetting of the solution 21 on the base material, the coating film 22 formed from the solution 21 becomes a dewetting material 23 having pores formed on the ruptured portion of coating film. The pores are referred to as dewetting pores. As described above, in the dewetting step 16, dewetting of the solution 21 on the base material occurs. Note that, in the dewetting step 16, the dewetting of the solution 21 is caused actively, or the dewetting of the solution 21 occurs on its own.

The critical thickness THc is expressed by an Equation 1 in which a density of the solution 21 is denoted by ρ, an acceleration of gravity is denoted by g, a surface tension of the solution 21 is denoted by γ, and a contact angle of the solution 21 to the base material is denoted by θs.

$$THc = 2 \sqrt{\frac{γ}{ρ g}} sin \frac{{θ}_{S}}{2} \qquad [ Equation 1 ]$$

Next, water drops each having a predetermined size are generated on the dewetting material 23 in the water drop formation process 12. The water drop formation process 12 consists of the condensation step 17 and the water drop growing step 18. In the condensation step 17, a wet gas (hereinafter referred to as wet air) is blown to the dewetting material 23. Water vapor is condensed from ambient air on a surface of the dewetting material 23 to generate water drops. In the water drop growing step 18, the wet air is further blown to the dewetting material 23 such that the water drops generated on the surface of the dewetting material 23 grow up to have a desired size. Accordingly, it is possible to form the dewetting material 23, whose surface has the water drops, from the solution 21 on the base material.

The dewetting material 23 is dried as follows in the drying process 13. The drying process 13 consists of the solvent evaporating step 19 and the water drop evaporating step 20. In the solvent evaporating step 19, a dry gas (hereinafter referred to as dry air) is blown to the dewetting material 23 whose surface has the water drops to evaporate a solvent contained in the dewetting material 23. In accordance with the evaporation of the solvent, the water drops enter the inside of the dewetting material 23. Note that the water drops enter the inside of the dewetting material 23 while keeping its shape and size without being mixed with the dewetting material 23 to be disappeared. The dewetting material 23 into which the water drops enter is referred to as a primary form 24. In the water drop evaporating step 20, the dry air is further blown to the primary form 24 to evaporate the water drops. Accordingly, in the drying process 13, the water drops enter the inside of the dewetting material 23 to form the primary form 24, and the pores are formed in the primary form 24 by utilizing the water drops as a template for a porous material. Thereby, a porous material 25 can be produced. As described above, the primary form 24 is formed in a primary form formation process 11. The primary form formation process 11 consists of the coating step 15, the dewetting step 16, the water drop formation process 12, and the solvent evaporating step 19 included in the drying process 13. Namely, the primary form 24 is formed during the drying process 13.

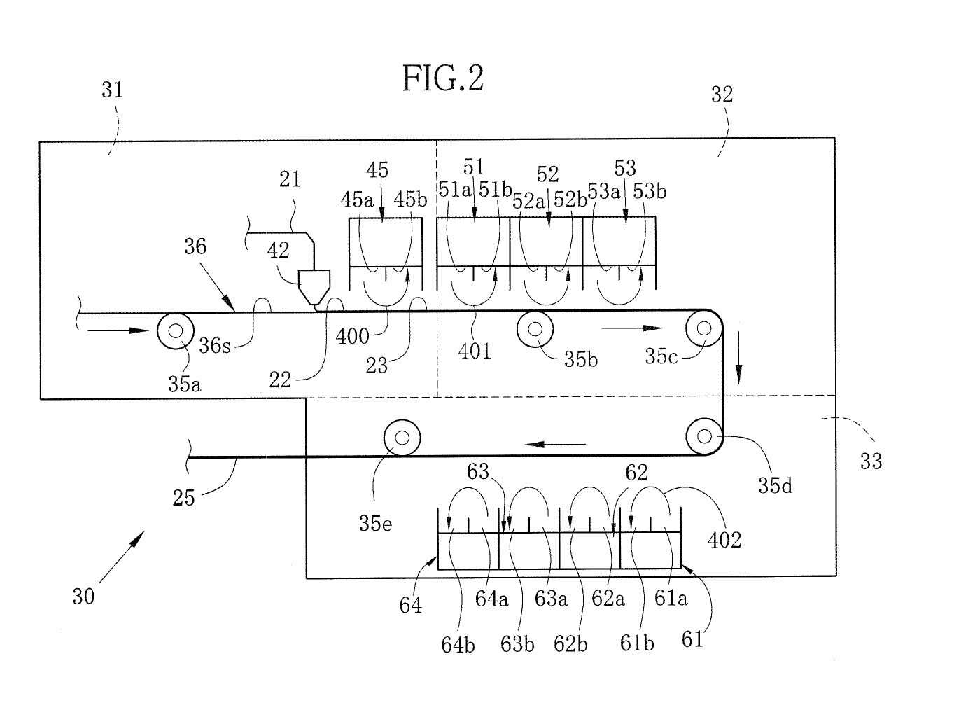

As shown in FIG. 2, a porous material production apparatus 30 is partitioned into a first area 31, a second area 32, and a third area 33 by not-shown partition plates. A roller 35a is disposed in the first area 31, rollers 35b and 35c are disposed in the second area 32, and rollers 35d and 35e are disposed in the third area 33. A polymer film 36 used as the base material is bridged over the rollers 35a to 35e. The roller 35e is driven to rotate by a not-shown driving unit, such that the polymer film 36 is guided by the rollers 35a to 35e to sequentially pass through the first area 31 to the third area 33.

(Polymer Film)

The material for forming the polymer film 36 is not especially limited. The preferable material for forming the polymer film 36 has sufficient chemical stability against the solvent to be used together, and heat resistance that is necessary during the porous material production procedure 10. As the preferable material for forming the polymer film 36, there are, for example, polymers such as polyethylene terephthalate (PET), polybutylene terephthalate (PBT), nylon 6, nylon 6,6, polypropylene, polycarbonate, polyimide, and cellulose acylate, and inorganic materials such as glass, stainless, and other metals. Further, the base material is not limited to the film, and may be a plate.

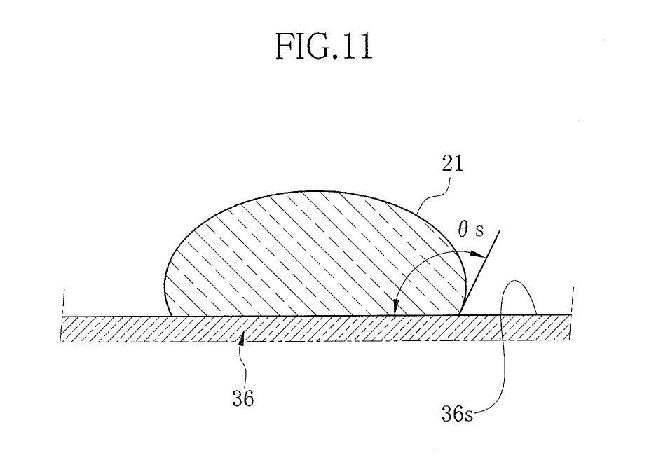

It is preferable that the surface 36s of the polymer film 36 is subjected to a predetermined surface treatment such that the wettability of the solution 21 after being subjected to the predetermined surface treatment is lower than the wettability of the solution 21 before being subjected to the predetermined surface treatment on the surface 36s of the polymer film 36. The surface treatment for the surface 36s may be a publicly known method. A contact angle θs of the solution 21 to the surface 36s is preferably in the range between 5° or more and 120° or less, and more referably in the range between 5° or more and 90° or less. As shown in FIG. 11, the contact angle θs can be measured by a shape of liquid drop formed from the solution 21 on the surface 36s of the polymer film 36. Further, when the contact angle θs of the solution 21 to the surface 36s is more than 120°, an arrangement pitch of the dewetting pores periodically arranged is increased, and consequently, the arrangement pitch of first pores arranged periodically is also increased, unfavorably. Note that, the first pores correspond to the dewetting pores formed on the porous material 25. In contrast, when the contact angle θs of the solution 21 to the surface 36s is less than 5°, the critical thickness TH0 becomes small. As a result, the solvent is evaporated from the dewetting material to dry and solidify the dewetting material prior to the condensation step and the water drop formation process, unfavorably.

Note that, in order to control the occurrence of dewetting, instead of adjusting the contact angle θs of the solution 21, the coating step 15 (see FIG. 1) may be performed so as to satisfy a condition expressed by (Γ_{SG}−Γ_{LG}Γ_{SL})<0, in which Γ_{SL} denotes the interfacial tension between the surface 36s of the polymer film 36 and the solution 21, Γ_{SG} denotes the interfacial tension between the surface 36s and atmosphere around the surface 36s, and Γ_{LG} denotes the interfacial tension between the solution 21 and the atmosphere around the surface 36s. As an example of controlling the occurrence of dewetting, when vapor pressure of the solvent in the atmosphere around the surface 36s is decreased, the dewetting of the solution 21 more easily occurs. In contrast, when the vapor pressure of the solvent in the atmosphere around the surface 36s is increased, the dewetting of the solution 21 does not easily occur. As described above, it is also possible to control the occurrence of dewetting by adjusting the vapor pressure of the solvent in the atmosphere around the surface 36s. Additionally, instead of adjusting the vapor pressure of the solvent, vapor pressure of the water or vapor pressure of both of the solvent and the water may be adjusted in order to control the occurrence of dewetting.

(First Area)

A coating die 42 is provided in the first area 31. The coating die 42 is connected to a not-shown stock tank for storing the solution 21 through a not-shown pipe. The coating die 42 has a discharge port through which the solution 21 is discharged. The coating die 42 is disposed in proximate to the surface 36s such that the discharge port faces the surface 36s. A dry air feeding device 45 is disposed in a downstream side from the coating die 42 in a moving direction of the polymer film 36 in the first area 31. The dry air feeding device 45 has an outlet 45a through which dry air 400 is fed, an inlet 45b through which the dry air 400 is sucked, and a not-shown blowing controller. The outlet 45a and the inlet 45b are provided at the dry air feeding device 45 so as to face the surface 36s of the polymer film 36 passing thorough the first area 31. The blowing controller provided at the dry air feeding device 45 is controlled by a not-shown controlling unit to adjust a temperature TA0 and a dew point TD0 of the dry air 400 to be fed through the outlet 45a, a condensation point TR0 of the solvent vapor in the dry air 400, and the like, such that the TA0, TD0, TR0, and the like are approximately constant within a desired range.

(Second Area)

Wet air feeding devices 51 to 53 are arranged in this order from the upstream side in the moving direction of the polymer film 36 in the second area 32. Each of the wet air feeding devices 51 to 53 has the same structure as that of the dry air feeding device 45. The wet air feeding device 51 has an outlet 51a through which the wet air 401 is fed, an inlet 51b through which the wet air 401 is sucked, and a not-shown blowing controller. The blowing controller provided at the wet air feeding device 51 is controlled by a not-shown controlling unit to adjust a temperature TA1 and a dew point TD1 of the wet air 401 to be fed through the outlet 51a, a condensation point TR1 of the solvent vapor in the wet air 401, and the like, such that the TA1, TD1, TR1, and the like are approximately constant within a desired range. In the similar manner, the wet air feeding device 52 has an outlet 52a through which the wet air 401 is fed, an inlet 52b through which the wet air 401 is sucked, and a not-shown blowing controller, and the wet air feeding device 53 has an outlet 53a through which the wet air 401 is fed, an inlet 53b through which the wet air 401 is sucked, and a not-shown blowing controller. The blowing controller provided at each of the wet air feeding devices 52 and 53 is controlled by a not-shown controlling unit to adjust a temperature TA1 and a dew point TD1 of the wet air 401 to be fed through each of the outlets 52a and 53a, a condensation point TR1 of the solvent vapor in the wet air 401, and the like, such that the TA1, TD1, TR1, and the like are approximately constant within a desired range. Note that, in order to grow the water drops generated on the coating film 22 uniformly, the wet air feeding devices 52 and 53 for performing the water drop growing step 18 (see FIG. 1) are preferably disposed in the downstream from and adjacent to the wet air feeding device 51 for performing the condensation step 17 (see FIG. 1)

(Third Area)

Dry air feeding devices 61 to 64 are arranged in this order from the upstream side in the moving direction of the polymer film 36 in the third area 33. Each of the dry air feeding devices 61 to 64 has the same structure as that of the dry air feeding device 45. The dry air feeding device 61 has an outlet 61a through which the dry air 402 is fed, an inlet 61b through which the dry air 402 is sucked, and a not-shown blowing controller. The dry air feeding device 62 has an outlet 62a through which the dry air 402 is fed, an inlet 62b through which the dry air 402 is sucked, and a not-shown blowing controller. The dry air feeding device 63 has an outlet 63a through which the dry air 402 is fed, an inlet 63b through which the dry air 402 is sucked, and a not-shown blowing controller. The dry air feeding device 64 has an outlet 64a through which the dry air 402 is fed, an inlet 64b through which the dry air 402 is sucked, and a not-shown blowing controller. The blowing controller provided at the dry air feeding device 61 is controlled by a not-shown controlling unit to adjust a temperature TA2 and a dew point TD2 of the dry air 402 to be fed through the outlet 61a, a condensation point TR2 of the solvent vapor in the dry air 402, and the like, such that the TA2, TD2, TR2, and the like are approximately constant within a desired range. In the similar manner, the blowing controller provided at each of the dry air feeding devices 62 to 64 is controlled by a not-shown controlling unit to adjust a temperature TA2 and a dew point TD2 of the dry air 402 to be fed through each of the outlets 62a to 64a, a condensation point TR2 of the solvent vapor in the dry air 402, and the like, such that the TA2, TD2, TR2, and the like are approximately constant within a desired range.

Next, an operation of the present invention is described hereinbelow. As shown in FIG. 2, the roller 35e is driven to rotate such that the polymer film 36 sequentially passes through the first area 31 to the third area 33.

The solution 21 stored in the not-shown stock tank is supplied to the coating die 42. The solution 21 is preferably filtered before being supplied to the coating die 42. Thus, it is possible to prevent foreign substances from being mixed into the porous material 25. The filtration is preferably performed plural times. For example, in a case where the filtration is performed twice, it is preferable that two filtering devices (not-shown) are disposed in series. The upstream one of the two has a filter whose absolute filtration accuracy (absolute filtration pore diameter) is larger than a pore diameter of the porous material 25, and the downstream one of the two has a filter whose absolute filtration accuracy is smaller than the pore diameter of the porous material 25.

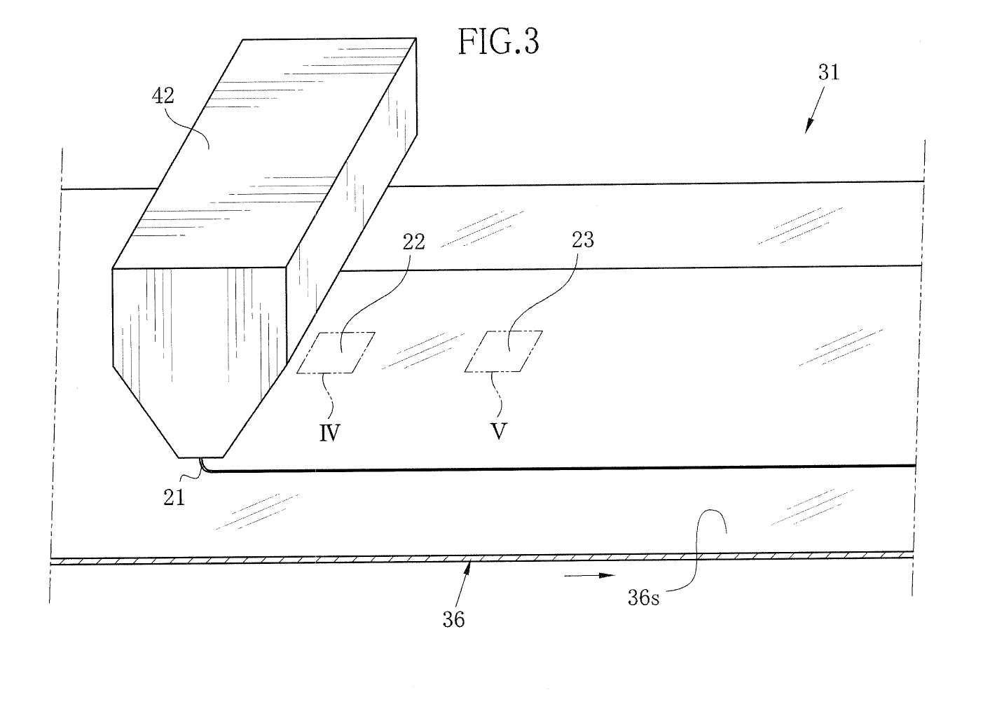

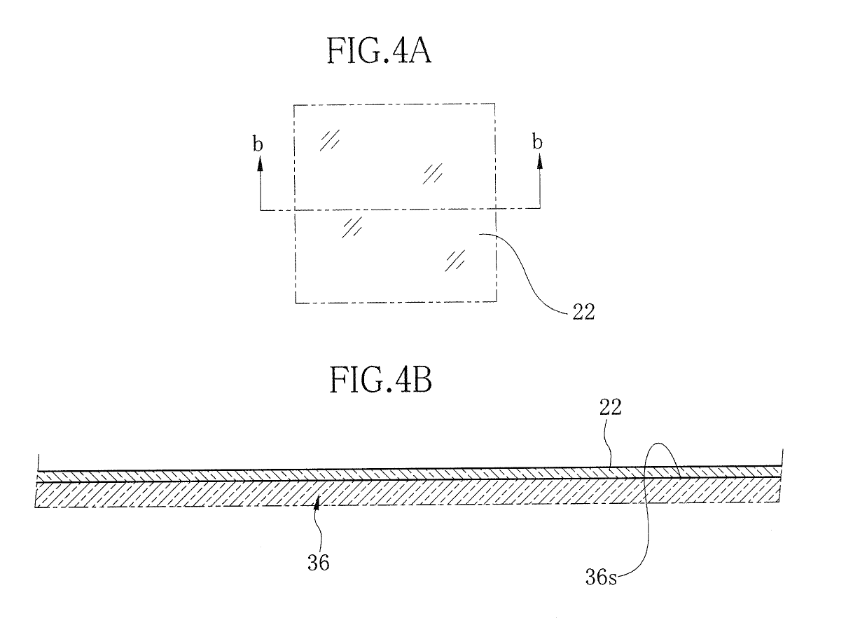

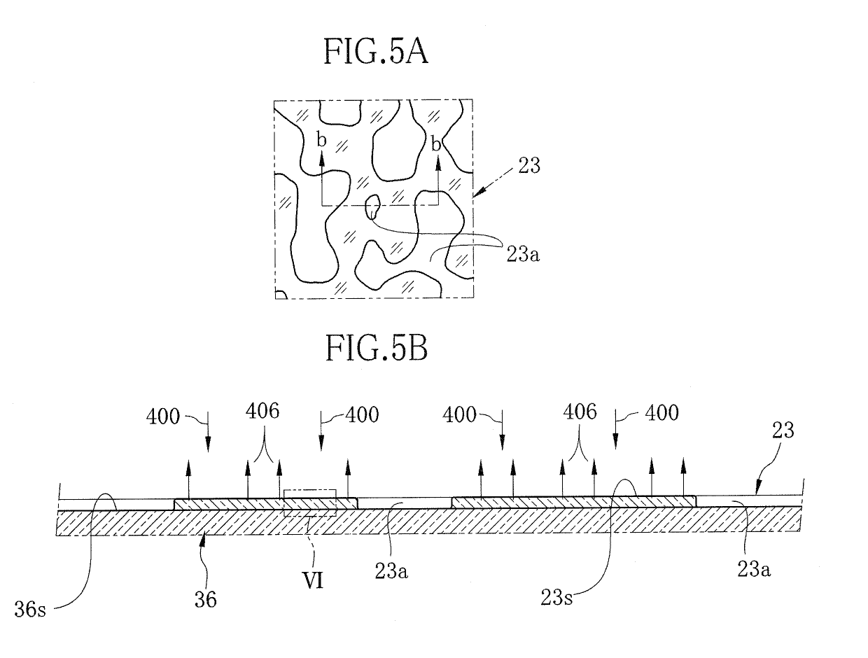

In FIG. 3, the solution 21 is discharged through the discharge port of the coating die 42 toward the surface 36s of the polymer film 36 in the first area 31. As shown in FIGS. 3 and 4, the discharged solution 21 becomes the coating film 22 on the surface 36s. The wettability of the solution 21 is low on the surface 36s. Since the thickness of the coating film 22 is the critical thickness THc or less, the dewetting of the solution 21 occurs after the solution 21 becomes the coating film 22 once. In FIGS. 3 and 5, when the dewetting of the solution 21 occurs on the surface 36s, the coating film 22 becomes the dewetting material 23 having the dewetting pores 23a in accordance with fluidity of the solution 21 for forming the coating film 22. Note that in order to form the coating film 22 having a uniform thickness, it is preferable that the coating film 22 just after being formed has a thickness of 10 μm or more.

Then, in FIGS. 2 and 5B, dry air 400 is uniformly blown to an entire surface 23s of the dewetting material 23 by the dry air feeding device 45 in the first area 31. The dry air 400 is caused to contact with the dewetting material 23 to evaporate the solvent 406 contained in the dewetting material 23. Thereby, the fluidity of the solution 21 for forming the dewetting material 23 is decreased. When the fluidity of the solution 21 becomes a predetermined level or less, it is possible to prevent the formation and growth of the dewetting pores 23a.

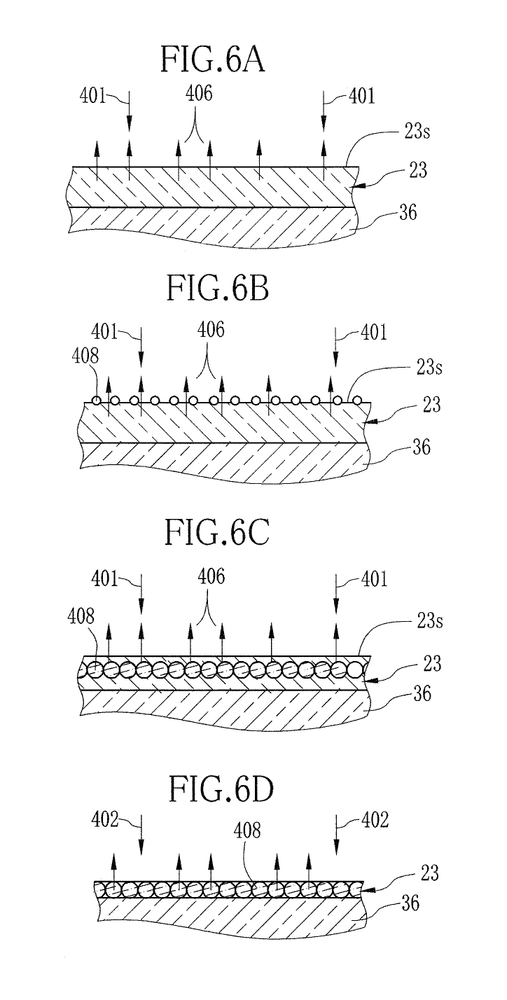

In FIG. 2, the wet air 401 is uniformly blown to the entire surface 23s of the dewetting material 23 by the wet air feeding device 51 in the second area 32 (see FIG. 6A). The wet air 401 is caused to contact with the dewetting material 23 to evaporate the solvent 406 contained in the dewetting material 23. Water vapor is condensed from ambient air on the surface 23s of the dewetting material 23 to approximately uniformly generate water drops 408 on the surface 23s (see FIG. 6B). Then, the wet air 401 is further uniformly blown to the entire surface 23s of the dewetting material 23 by the wet air feeding devices 52 and 53. The wet air 401 is caused to contact with the dewetting material 23 to evaporate the solvent 406 contained in the dewetting material 23. The water drops 408 grow up approximately uniformly to have a desired size. While growing up, the water drops 408 enter the inside of the dewetting material 23 as shown in FIGS. 6B and 6C. Namely, the primary form 24 is formed.

As shown in FIG. 2, the dry air 402 is blown to the surface 23s of the dewetting material 23 by the dry air feeding devices 61 to 64 in the third area 33. As shown in FIG. 6D, the dry air 402 is caused to contact with the dewetting material 23 to evaporate the water drops 408 from the dewetting material 23, and thereby the pores are formed on the dewetting material 23 by utilizing the water drops 408 as a template for a porous material. As a result, the porous material 25 of the present invention can be obtained. Note that, when the solvent 406 is remained in the dewetting material 23, the solvent 406 may be evaporated together with the water drops 408 from the dewetting material 23.

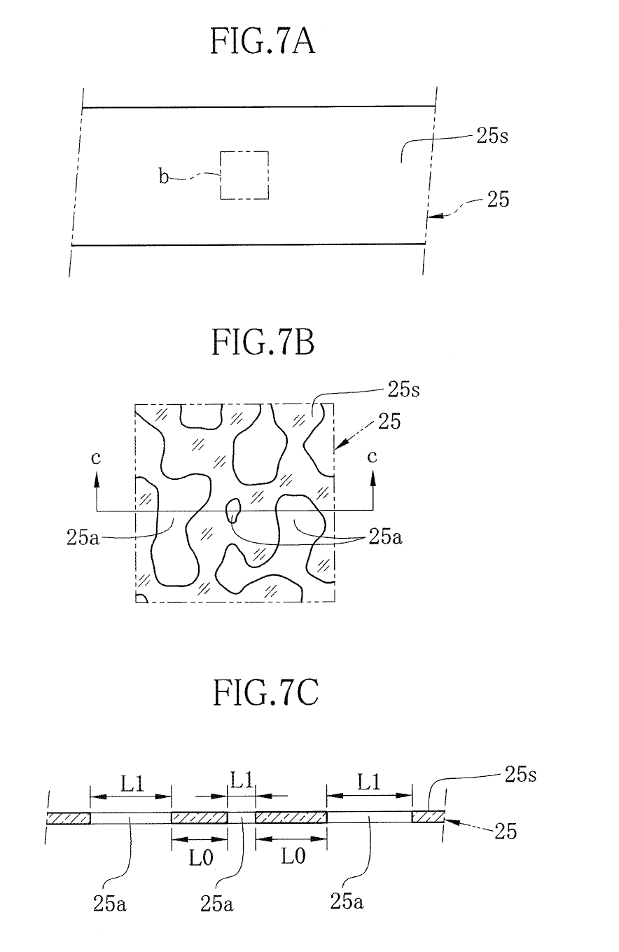

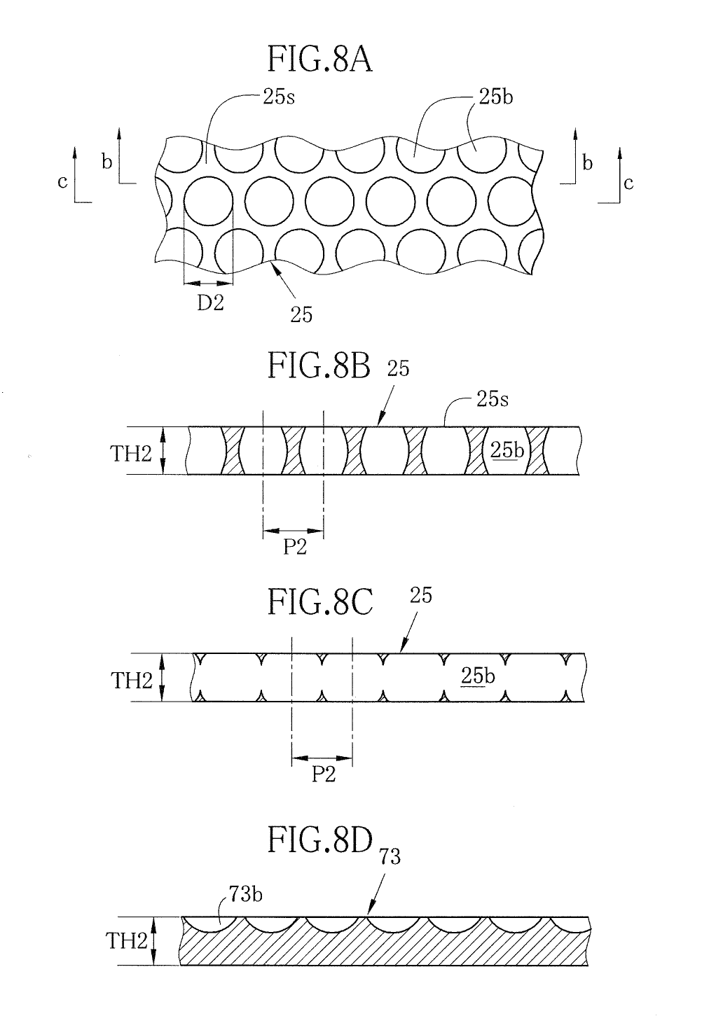

As shown in FIGS. 7 and 8, the porous material 25 has first pores 25a which are the dewetting pores 23a of the dewetting material 23, and second pores 25b formed by utilizing the water drops 408 as a template for a porous material. The first pores 25a are preferably formed in an arrangement pitch of submillimeter order to millimeter order. Namely, as shown in FIG. 7C, in the cross section of the porous material 25 including the thickness direction of the porous material 25, a length L0 of a portion in which the first pore 25a is not formed, and a length L1 of a portion in which the first pore 25a is formed are respectively in the range of between 0.1 mm or more and 10 mm or less.

The second pores 25b are formed so as to constitute a so-called honeycomb structure. As shown in FIG. 8A, the second pores 25b having an approximately specific shape and size are arranged regularly. The second pores 25b are formed so as to penetrate both surfaces of the porous material 25 as shown in FIGS. 8B and 8C in some cases, and the second pores 25b are formed as dimples 73b on one surface of a porous material 73 as shown in FIG. 8D in other cases. The arrangement of each of the second pores 25b and the dimples 73b varies in accordance with degree of density and size of the water drops, kinds of liquid drops to be formed, a drying speed, solid content concentration of the solution, timing of evaporation of the solvent corresponding to the growth degree of the water drops, and the like. Although the configuration of the porous material 25 of the present invention is not especially limited, it is particularly effective to produce a porous material in which the thickness TH2 of the porous material 25 is in the range between 0.05 μm or more and 100 μm or less, a diameter D2 of the second pores 25b is in the range between 0.05 μm or more and 100 μm or less, a distance P2 between centers of the adjacent second pores 25b is in the range of between 0.1 μm or more and 120 μm or less, for example.

The honeycomb structure means a structure in which the pores each having a specific shape and size are arranged regularly in a specific direction as described above. The regular arrangement of the pores is two dimensional in a case where the porous material is a single-layer film, and three dimensional in a case where the porous material is a multi-layer film. In the two dimensional arrangement of the pores, one pore is surrounded by plural (for example, 6) pores. In the three dimensional arrangement of the pores, the pores are formed most densely in a face-centered cubic structure or a hexagonal structure in many cases. However, in some production conditions, the other arrangements are made. Note that the number of pores formed around one pore on the same plane is not limited to six, and may be three to five, or seven or more.

In the porous material production procedure 10 (see FIG. 1) of the present invention, the porous material 25 includes the first pores 25a formed by utilizing dewetting of the solution 21, and the second pores 25b formed by the utilizing the water drops 408 generated by the condensation as a template for a porous material. Therefore, according to the present invention, it is possible to readily produce the porous material 25 in which the first pores 25a and the second pores 25b are arranged in a periodic distance different from each other.

The size of the first pores 25a can be controlled by adjusting the fluidity of the solution 21 for forming the dewetting material 23. The size of the second pores 25b can be controlled by adjusting a parameter ΔTw described later independently from the size of the first pores 25a. Therefore, according to the present invention, it is possible to form microasperities having a periodic distance different from each other at high precision.

Hereinbelow, preferred modes and conditions for each step are described.

(Coating Step)

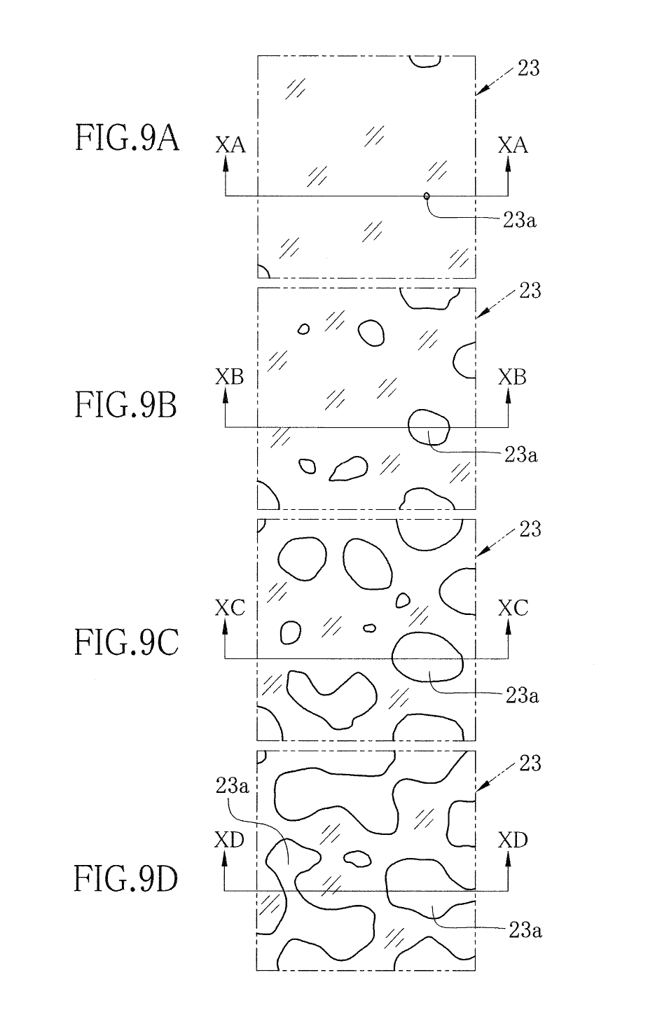

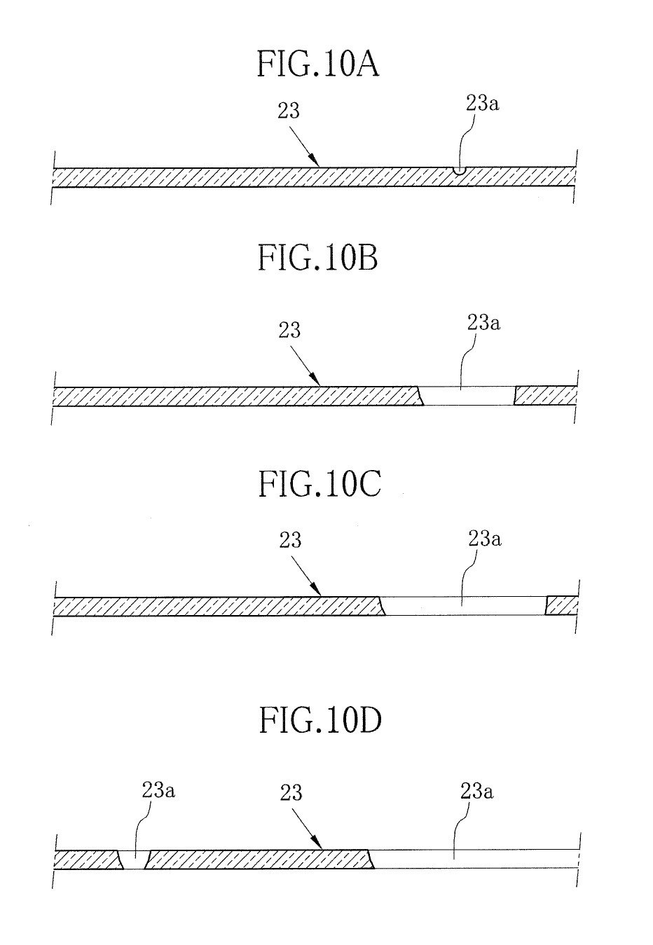

After starting the dewetting of the solution 21, in a case where the fluidity of the solution 21 is above a predetermined level, the dewetting pores 23a are formed as dimples on the surface 36s, and then grow up such that a length L1 (see FIG. 7C) thereof becomes long or such that a depth thereof becomes deeper (see FIGS. 9A, 9B, 10A, and 10B). Thereby, the dewetting pores 23a become through holes to expose the surface 36s of the polymer film 36 outside (see FIGS. 9B to 9D and 10B to 10D). In the present invention, the dewetting pores 23a may be dimples as shown in FIG. 10A, or through holes as shown in FIGS. 10B to 10D.

Whether the dewetting pores 23a are formed as the dimples or as the through holes can be decided by the growth degree of the dewetting pores 23a. The growth degree of the dewetting pores 23a can be controlled by adjusting the dewetting time, the contact angle θs of the solution 21 to the surface 36s, the viscosity of the solution 21, and the like. The dewetting time is amount of time required for the fluidity of the solution 21 to achieve a certain level for preventing the formation and growth of the dewetting pores 23a after the start of dewetting of the solution 21. As the dewetting time becomes shorter, the contact angle θs becomes smaller, or the viscosity of the solution 21 becomes higher, the growth degree of the dewetting pores 23a becomes lower. In contrast, as the dewetting time becomes longer, the contact angle θs becomes larger, or the viscosity of the solution 21 becomes lower, the growth degree of the dewetting pores 23a becomes higher.

In the first area 31 (see FIG. 3), as shown in FIG. 5B, the dry air 400 is continuously blown to the dewetting material 23 to evaporate the solvent 406 from the dewetting material 23 until the fluidity of the solution 21 achieves a certain level for preventing the growth of the dewetting pores 23a. Therefore, it is possible to control the growth degree of the dewetting pores 23a by adjusting a parameter ΔTsolv obtained by subtracting a temperature TS of the surface 23s from the condensation point TR0 of the solvent vapor in the dry air 400. In the similar manner, it is possible to control the growth degree of the dewetting pores 23a by adjusting the contact angle θs, the composition of the solution 21, and the temperature of the solution 21, or combination thereof. Note that under the atmosphere in which the solvent 406 is evaporated from the dewetting material 23, it is unnecessary to blow the dry air 400 toward the dewetting material 23.

Note that, in a case where the first pores 25a are formed as the dimples, the second pores 25b may be formed on only a portion of the surface 25s of the porous material 25 having no dimples, or alternatively, the second pores 25b may be formed on the entire surface 25s of the porous material 25, in other words, both of a portion having no dimples and a portion having the dimples. It is possible to form the second pores 25b on only the portion having no dimples by adjusting a parameter ΔTw as described later.

Although the dewetting material 23 having the fluidity at a certain level for preventing the growth of the dewetting pores 23a is subjected to the condensation step 17 (see FIG. 1) in the above embodiment, the present invention is not limited thereto. It is also possible to subject the dewetting material 23 before the growth of the dewetting pores 23a is prevented to the condensation step 17 (see FIG. 1) or both of the condensation step 17 and the water drop growing step 18. Note that, in a case where the dewetting material 23 is subjected to both of the condensation step 17 and the water drop growing step 18, the dry air feeding device 45 may be omitted.

Although the solution 21 is applied to the polymer film 36 by using the coating die 42 in the above embodiment, the present invention is not limited thereto. Other publicly known coating methods such as blade coating, spin coating, dip coating, and inkjet printing may be adopted in the present invention.

(Condensation Step and Water Drop Growing Step)

As shown in FIGS. 6A to 6C, in the second area 32 (see FIG. 2), the cores of the water drops 408 are formed and grown up on the surface 23s. The formation amount of cores of the water drops 408 and the growth degree of cores of the water drops 408 can be controlled by adjusting the parameter ΔTw obtained by subtracting the temperature TS of the surface 23s from the dew point TD1 of the wet air 401. In order to form the cores of the water drops 408, the parameter ΔTw is preferably in the range of 0.5° C. to 30° C., and more preferably in the range of 1° C. to 20° C. In order to grow the cores of the water drops 408, the parameter ΔTw is preferably in the range of 0° C. to 20° C., and more preferably in the range of 0° C. to 10° C. Note that, although the wet air 401 fed from the wet air feeding device 51 is utilized to form the cores of the water drops 408 and the wet air 401 fed from the wet air feeding devices 52 and 53 is utilized to grow the cores of the water drops 408 in the above embodiment, the present invention is not limited thereto. It is also possible to utilize the wet air 401 fed from the wet air feeding devices 51 and 52 to form the cores of the water drops 408 and utilize the wet air 401 fed from the wet air feeding device 53 to grow the cores of the water drops 408.

For the purpose of utilizing the water drops 408 as the template for the porous material, it is preferable that the solvent is evaporated such that the fluidity of the solution 21 for forming the dewetting material 23 achieves a certain level for preventing the formation and growth of cores of the water drops 408. Therefore, the parameter ΔTsolv obtained by subtracting the temperature TS of the surface 23s from the condensation point TR1 of the solvent vapor in the wet air 401 is preferably less than 0° C.

The temperature TS of the surface 23s of the dewetting material 23 in the second area 32 is preferably in the range of −5° C. to 30° C. The dew point TD1 of the wet air 401 is preferably in the range of 5° C. to 30° C. The temperature TA1 of the wet air 401 is preferably in the range of 5° C. to 30° C.

Although the wet air 401 is blown to the dewetting material 23 and water vapor is condensed from ambient air on the surface 23s to generate the water drops 408 on the surface 23s in the above embodiment, the present invention is not limited thereto. It is also possible to use an inkjet unit to generate the water drops 408 on the surface 23s. The inkjet unit includes an inkjet head, a head driver, and a controller. Namely, the inkjet unit has the same structure as that of a common inkjet printer. The difference between the inkjet unit to be used in the present invention and the common inkjet printer lies in that water is used to generate the water drops as a template for pores in a porous material instead of using ink in the inkjet unit to be used in the present invention. The discharging system of the inkjet unit may be either a linear discharging system or a serial discharging system.

(Solvent Evaporating Step and Water Drop Evaporating Step)

In the third area (see FIG. 2), in order to evaporate the water drops 408, the parameter ΔTW obtained by subtracting the temperature TS of the surface 23s from the dew point TD2 of the dry air 402 is preferably at most 0° C., and more preferably in the range of −30° C. to −5° C. The temperature TS of the surface 23s in the drying process 13 (see FIG. 1) is preferably in the range of 10° C. to 40° C. The dew point TD2 of the dry air 402 is preferably at most 10° C. The temperature TA of the dry air 402 is preferably in the range of 10° C. to 100° C.

Although the coating film 22 having an approximately uniform thickness is formed in the coating step 15 (see FIG. 1) in the above embodiment, the present invention is not limited thereto. It is also possible to form a coating film having thickness distribution in which one part is thinner than the critical thickness THc and another part is thicker than the critical thickness THc. Thereby, it is possible to produce a porous material in which an area having both of the first pores and the second pores, an area having only the first pores, and an area having only the second pores are mixed. A method for forming the coating film having such thickness distribution includes the following steps, for example. A blade whose front end has concavity and convexity is slid so as to contact with the surface of the base material. Thereby, a coating film having thickness distribution corresponding to the shape of the front end of the blade can be formed on the surface of the base material.

Although the coating film 22 whose thickness is at most the critical thickness THc is formed in the coating step 15 (see FIG. 1) in the above embodiment, the present invention is not limited thereto. It is also possible to form the coating film 22 thicker than the critical thickness THc in the coating step 15. In a case where the thickness of the coating film 22 is thicker than the critical thickness THc, the dewetting of the discharged solution 21 does not occur on the surface 36s of the polymer film 36, such that the solution 21 remains to be the coating film 22 on the surface 36s of the polymer film 36. In a case where the solution 21 remains to be the coating film 22 on the surface 36s of the polymer film 36, it is also possible to form the dewetting material 23 from the coating film 22 by performing a film thickness decreasing step. In the film thickness decreasing step, the dry air 400 is blown to the coating film 22 until the thickness of the coating film 22 becomes the critical thickness THc or less to evaporate the solvent 406 from the coating film 22. Note that it is also possible to subject the coating film 22 which is formed in the coating step 15 and thicker than the critical thickness THc to the condensation step 17 and then the film thickness decreasing step.

Although the base material used in the above embodiment has a surface on which the dewetting of the solution easily occur, namely, the wettability of the solution is relatively low on the surface of the base material, the present invention is not limited thereto. The base material having a surface on which the wettability of the solution is relatively high also may be used in the present invention. When such a base material is used, the base material may be subjected to a surface treatment such that the contact angle of the solution to the surface achieves a predetermined level prior to the coating step 15 (see FIG. 1). Additionally, a surface to which the contact angle of the solution is uniform may be disposed on the entire surface of the base material. Alternatively, a surface A to which the contact angle of the solution is θa and a surface B to which the contact angle of the solution is θb may be disposed on the surface of the base material. Note that, θb is smaller than θa. The first pores are more readily formed on the surface A in comparison with the surface B. Therefore, an area on which the surface A is disposed and pattern of the surface A may be arbitrarily adjusted in order to form the first pores having a desired pattern on a desired area of the porous material.

The porous material of the present invention has a surface in which pores are formed or on which dimples are formed. Therefore, the porous material of the present invention includes not only the porous material 25 peeled from the polymer film 36 but also the polymer film 36 having the porous material 25 formed on the surface 36s. In a case where a final product is only the porous material 25, a separation device for separating the porous material 25 from the polymer film 36 may be provided in the downstream side from the third area 33 in the moving direction of the polymer film 36. For the purpose of separating the porous material 25 from the polymer film 36, the porous material 25 may be peeled from the polymer film 36, and alternatively, it is also possible to dissolve the polymer film 36 by a solvent. Further, a cutting device may be provided between the third area 33 and the separation device to cut the porous material 25 together with the polymer film 36. Alternatively, the cutting device may be provided in the downstream side from the separation device in the moving direction of the polymer film 36 to cut the porous material 25 separated from the polymer film 36. Furthermore, in a case where the final product is the polymer film 36 having the porous material 25 formed on the surface 36s, a cutting device for cutting the polymer film 36 having the porous material 25 on the surface into a predetermined size may be provided in the downstream side from the third area 33 in the moving direction of the polymer film 36.

(Solution)

The solution 21 obtained by dissolving the polymer into the solvent is used in the porous material production procedure 10 of the present invention. The concentration of the polymer in the solution is sufficient as long as it can form the coating film 22. For example, the concentration of the polymer in the solution is preferably in the range between 0.01 mass % or more and 30 mass % or less. If the concentration of the polymer in the solution is less than 0.01 mass %, the productivity of the porous material is low, and therefore the solution may be unsuitable for industrial mass production in some cases. In contrast, when the concentration of the polymer in the solution is more than 30 mass %, the viscosity of the solution is increased, and therefore it may be difficult to form the coating film 22.

The viscosity of the solution 21 is preferably in a range between 1×10⁻⁴ Pa·s or more and 1×10⁻¹ Pa·s or less. In a case where the viscosity of the solution 21 is more than 1×10⁻¹ Pa·s, variation in the arrangement pitch of the pores unfavorably occurs. In contrast, in a case where the viscosity of the solution 21 is less than 1×10⁻⁴ Pa·s, the high fluidity of the solution 21 results in formation of water drops interconnected with each other. Thereby, variation in the diameter of the pores unfavorably occurs.

(Polymer)

The polymer as a material for the porous material is preferably dissolved into a water-insoluble solvent (hereinafter the polymer is referred to as hydrophobic polymer). Moreover, although only the hydrophobic polymer is sufficient to form the porous material, it is preferable that an amphiphilic polymer is used together with hydrophobic polymer.

(Solvent)

The solvent for preparing the solution is not especially limited as long as it has a hydrophobic character and can dissolve the polymer, and may be an organic solvent such as chloroform, dichloromethane, carbon tetrachloride, cyclohexane, methyl acetate, and the like.

(Hydrophobic Polymer)

The hydrophobic polymer is not especially limited, and may be appropriately selected among publicly known hydrophobic polymers in accordance with the purpose. Examples of the hydrophobic polymers are vinyl-type polymer (for example, polyethylene, polypropylene, polystyrene, polyacrylate, polymethacrylate, polyacrylamide, polymethacrylamide, polyvinyl chloride, polyvinylidene chloride, polyvinylidene fluoride, polyhexafluoropropene, polyvinyl ether, polyvinyl carbazol, polyvinyl acetate, polytetrafluoroethylene, and the like), polyesters (for example, polyethylene terephthalate, polyethylene naphthalate, polyethylene succinate, polybutylene succinate, polylactic acid, and the like), polylactone (for example, polycaprolactone and the like), polyamide or polyimide (for example, nylon, polyamic acid, and the like), polyurethane, polyurea, polybutadiene, polycarbonate, polyaromatics, polysulfone, polyethersulfone, polysiloxane derivative, cellulose acylate (for example, triacetyl cellulose, cellulose acetate propionate, cellulose acetate butyrate, and the like), and the like. These may be used in the form of homo polymer, and otherwise used as copolymer or polymer blend as necessary, in view of solubility, optical physical properties, electric physical properties, film strength, elasticity, and the like. Note that these polymers may be used in the form of mixture containing two or more kinds of polymers as necessary. The polymers for optical purpose are preferably cellulose acylate, cyclic polyolefin, and the like, for example.

The amphiphilic polymer is not especially limited, and appropriately selected in accordance with the purpose. For example, there are an amphiphilic polymer which has a main chain of polyacrylamide, a hydrophobic side chain of dodecyl group, and a hydrophilic side chain of carboxyl group, a block copolymer of polyethylene glycol/polypropylene glycol, and the like.

The hydrophobic side chain is a group which has nonpolar normal (linear) chain such as alkylene group, phenylene group, and the like, and preferably has a structure in which a hydrophilic group such as polar group or ionic dissociative group is not divided until the end of the chain, except a linking group such as ester group and amide group. The hydrophobic side chain preferably has at least five methylene units if it is composed of alkylene group. The hydrophilic side chain preferably has a structure having a hydrophilic part such as polar group, ionic dissociative group, or oxyethylene group on the end through a linking part such as alkylene group.

The ratio of the hydrophobic side chain to the hydrophilic side chain varies depending on the size of the side chain, the intensity of polarity, the strength of hydrophobicity of the hydrophobic organic solvent, or the like, and cannot be specified in general. However, the unit ratio (hydrophilic side chain:hydrophobic side chain) is preferably in the range of 0.1:9.9 to 4.5:5.5. Further, in a case of the copolymer, a block copolymer, in which blocks of the hydrophobic side chain and blocks of the hydrophilic side chain do not affect the solubility thereof in the hydrophobic solvent, is preferably used in comparison with an alternating polymer of a hydrophobic side chain and a hydrophilic side chain.

The number average molecular weight (Mn) of the hydrophobic polymer and the amphiphilic polymer is preferably in the range of 1,000 to 10,000,000, and more preferably in the range of 5,000 to 1,000,000.

The composition ratio (mass ratio) of the hydrophobic polymer to the amphiphilic polymer is preferably in a range of 99:1 to 50:50, and more preferably in range of 98:2 to 70:30. In a case where the ratio of the amphiphilic polymer is less than 1 mass %, a porous material in which the pores are uniform in size cannot be obtained in some cases. In contrast, in a case where the ratio of the amphiphilic polymer is more than 50 mass %, stability of the coating film, in particular, mechanical stability thereof cannot be obtained sufficiently in some cases.

It is also preferable that the hydrophobic polymer and the amphiphilic polymer to be used as the material of the porous material are a polymerizable (crosslinkable) polymer having a polymerizable group in its molecule. Further, preferably, a polymerizable polyfunctional monomer is blended together with the hydrophobic polymer and/or the amphiphilic polymer, and after forming a honeycomb film by the blending, the blended material is cured by a publicly known method such as a thermal curing method, a UV curing method, or an electron beam curing method.

As the polyfunctional monomer that can be used together with the hydrophobic polymer and/or the amphiphilic polymer, polyfunctional (meth)acrylate is preferable from the viewpoint of reactivity. As the polyfunctional (meth)acrylate, for example, there can be used dipentaerythritol pentaacrylate, dipentaerythritol hexaacrylate, dipentaerythritol caprolactone adduct hexaacrylate or a modified compound thereof, an epoxy acrylate oligomer, a polyester acrylate oligomer, a urethane acrylate oligomer, N-vinyl-2-pyrrolidone, tripropylene glycol diacrylate, polyethylene glycol diacrylate, trimethylolpropane triacrylate, pentaerythritol triacrylate, pentaerythritol tetraacrylate or a modified compound thereof, and the like. These polyfunctional monomers are used alone or in combination of two or more types thereof from the viewpoint of the balance between resistance to abrasion and flexibility.

In a case where the hydrophobic polymer and the amphiphilic polymer are a polymerizable (crosslinkable) polymer having a polymerizable group in its molecule, it is also preferred to use a polymerizable polyfunctional monomer that can react with the polymerizable group of the hydrophobic polymer and the amphiphilic polymer.

The monomer having an ethylene type unsaturated group can be polymerized by irradiation of ionizing radiation or heating under the presence of a photoradical initiator or a thermal radical initiator. Accordingly, a coating liquid containing the monomer having the ethylene type unsaturated group, the photoradical initiator or the thermal radical initiator, matting particles, and inorganic filler is prepared, and then the coating liquid is applied on a transparent base material and cured by polymerization reaction caused by the ionizing radiation or heating. Thereby, a porous material capable of being used as an antireflection film can be produced.

As the photoradical initiator, there are acetophenones, benzoins, benzophenones, phosphine oxides, ketals, anthraquinones, thioxanthones, azo compounds, peroxides, 2,3-alkyl dion compounds, disulfide compounds, fluoroamine compounds, and aromatic sulfoniums, for example.

As the acetophenones, there are 2,2-ethoxyacetophenone, p-methylacetophenone, 1-hydroxydimethyl phenyl ketone, 1-hydroxycyclohexyl phenyl ketone, 2-methyl-4-methylthio-2-morpholinopropiophenone, 2-benzyl-2-dimethylamino-1-(4-morpholinophenyl)-butanone, and the like for example.

As the benzoins, there are benzoin benzenesulfonic ester, benzoin toluenesulfonic ester, benzoin methyl ether, benzoin ethyl ether, benzoin isopropyl ether, and the like, for example.

As the benzophenones, there are benzophenone, 2,4-chlorobenzophenone, 4,4-dichlorobenzophenone, p-chlorobenzophenone, and the like, for example.

As the phosphine oxides, there are 2,4,6-trimethylbenzoyl diphenylphosphine oxide and the like, for example.

Various examples of the photoradical initiator are described in “Saishin UV-Koka Gijutsu (Latest UV Curing Technologies)” (page 159, publisher: Kazuhiro TAKABO; publishing company: Technical Information Institute CO., LTD, 1991). As a preferable example of a commercially available photocleavage-type photoradical initiator, there is Irgacure (651,184,907) produced by Chiba Specialty Chemicals CO., Ltd (Ciba Japan K.K.).

The photoradical initiator is preferably used within a range of 0.1 to 15 parts by mass, and more preferably within a range of 1 to 10 parts by mass, relative to 100 parts by mass of the polyfunctional monomer.

Note that a photosensitizer may be used in addition to the photoradical initiator. As the example of the photosensitizer, there are n-butylamine, triethylamine, tri-n-butylphosphine, Michler's ketone, thioxanthone, and the like.

As the thermal radical initiator, organic peroxide, inorganic peroxide, organic azo compound, organic diazo compound, and the like can be used, for example.

As the organic peroxide, there are benzoyl peroxide, halogen benzoyl peroxide, lauroyl peroxide, acetyl peroxide, dibutyl peroxide, cumene hydroperoxide, butyl hydroperoxide, and the like, for example. As the inorganic peroxide, there are hydrogen peroxide, ammonium persulfate, potassium persulfate, and the like, for example. As the azo compound, there are 2,2′-azobis(isobutyronitrile), 2,2′-azobis(propionitrile), 1,1′-azobis(cyclohexanecarbonitrile), and the like, for example. As the diazo compound, there are diazoaminobenzene, p-nitrobenzenediazonium, and the like, for example.

(Purpose)

The porous material of the present invention has a so-called net-like structure. When the porous material is used as a scaffold for cell culture, it is possible to culture cells on only a predetermined pattern. Further, the porous material having such a net-like structure is easily stretched and has excellent flexibility, and therefore can cover a curved surface or a moving part. Accordingly, the porous material of the present invention can be a three-dimensional porous material. When the three-dimensional porous material is used as the scaffold for the cell culture, it is possible to perform three-dimensional cell culture.

Further, in the porous material of the present invention, the first pores are arranged in a periodic distance of submillimeter order to millimeter order, and the second pores are arranged in a periodic distance of submicrometer order to micrometer order. Thereby, excellent water-repellent property can be exerted. Additionally, according to the present invention, when the porous material having a hydrophobic character is disposed on the surface of the base material having a hydrophilic character, it is possible to produce a porous composite material whose surface includes a hydrophilic area and a hydrophobic area, in which the hydrophilic area is the surface of the base material that is exposed outside through the first pores of the porous material and the hydrophobic area is the surface of the porous material. In a case where there is a portion on which water vapor should not be condensed from ambient air on the porous composite material, the hydrophobic area may be provided on the portion on which water vapor should not be condensed from ambient air, and the hydrophilic area may be provided on a portion on which water vapor can be condensed from ambient air.

### Example

### Experiment 1

The porous material 25 was produced in the porous material production apparatus 30. The solution was prepared by using chloroform as the solvent, polystyrene as the hydrophobic polymer, and an amphiphilic polymer having a hydrophobic side chain of dodecyl group and a hydrophilic side chain of carboxyl group. A concentration C1 of the hydrophobic polymer in the solution was 1 mg/mL. A surface tension γ of the solution was 27 mN/m. A viscosity ν of the solution was 1 mPa·s.

A glass plate was used as the base material. A contact angle θs of the solution to the glass plate was 20°. A critical thickness THc was 240 μm. The solution was applied to the glass plate so as to form a coating film having a thickness TH0 of 100 μm. The dewetting of the solution occurred, and thereby the dewetting material 23 was formed on the glass plate. The dry air 400 was blown to the dewetting material 23 so as to prevent the growth of cores of the dewetting pores 23a of the dewetting material 23. Next, the wet air 401 was blown to the dewetting material 23 to perform the condensation step 17 and the water drop growing step 18. Thereafter, the dry air 402 was brown to the dewetting material 23 to perform the drying process 13. Thereby, the porous material was obtained.

### Experiments 2 to 17

A porous material was produced in the same manner as Experiment 1 except that each of the parameters C1, γ, ν, θs, TH0, THc, and TH0/THc was set as shown in Table 1. In experiments 11 to 13, dichloromethane was used as the solvent. In experiments 14 to 17, polybutadiene was used as the hydrophobic polymer. In experiments 6 to 9, a plate made of Teflon (registered trademark) was used as the base material. In experiments 10 to 17, a PET film was used as the base material.

(Evaluation)

Evaluation was made on each of experiments 1 to 17 in accordance with the following items.

1. Whether or not Dewetting Occurred

Whether or not dewetting of the solution occurred on the base material was visually checked, and evaluation was made based on the following criteria.

P (Passed): Dewetting of the solution occurred on the base material.

F (False): Dewetting of the solution did not occur on the base material.

2. Coating Ratio

Coating ratio CR on the produced porous material was obtained and evaluated based on the following criteria. The coating ratio is an area occupied by the porous material relative to an area on which the solution is applied.

A: CR was in a range between more than 0% and less than 30%.

B: CR was in a range between 30% or more and less than 70%.

C: CR was in a range between 70% or more and less than 100%.

D: Dewetting did not occur and CR could not be measured.

3. Evaluation of Variation in Pore Diameters

Variation in diameters of the pores formed in the obtained porous material was evaluated based on the following criteria. The diameters of the pores formed in the obtained porous material were measured. A coefficient of variation is expressed by X/Y, in which a standard deviation of pore diameters is denoted by X and an average pore diameter is denoted by Y.

E (Excellent): Coefficient of variation was less than 10%.

G (Good): Coefficient of variation was in a range between 10% or more and less than 15%.

P (Passed): Coefficient of variation was 15% or more.

Each of the parameters C1, γ, ν, θs, TH0, THc, and TH0/THc, and evaluation results in each of the experiments 1 to 17 are shown in Table 1. The numbers assigned to the evaluation results in Table 1 correspond to the numbers of the above evaluation items.

As shown in Table 1, it was found that a porous material having a multiple-stage periodic structure of microasperities can be produced according to the present invention.

TABLE 1

| | | | | | | | | | Evaluation Result | | | |
|---|---|---|---|---|---|---|---|---|---|---|---|---|
| | | C1 | γ | ν | θs | TH0 | THc | | | | 3 | |
| | | (mg/mL) | (mN/m) | (mPa · s) | (°) | (μm) | (μm) | TH0/THc | 1 | 2 | Y | X/Y |
| Ex | 1 | 1 | 27 | 1 | 20 | 100 | 240 | 0.4 | P | B | 0.7 | E |
| | 2 | 1 | 27 | 1 | 20 | 200 | 240 | 0.8 | P | C | 1.2 | E |
| | 3 | 1 | 27 | 1 | 20 | 500 | 240 | 2.1 | F | D | 8.0 | E |
| | 4 | 200 | 27 | 150 | 20 | 100 | 240 | 0.4 | P | B | 0.8 | P |
| | 5 | 200 | 27 | 150 | 20 | 500 | 240 | 2.1 | F | D | 8.0 | P |
| | 6 | 1 | 27 | 1 | 40 | 100 | 470 | 0.2 | P | A | 1.0 | E |
| | 7 | 1 | 27 | 1 | 40 | 200 | 470 | 0.4 | P | B | 2.5 | E |
| | 8 | 1 | 27 | 1 | 40 | 400 | 470 | 0.9 | P | C | 8.0 | E |
| | 9 | 1 | 27 | 1 | 40 | 700 | 470 | 1.5 | F | D | 9.0 | E |
| | 10 | 1 | 27 | 1 | 10 | 100 | 130 | 0.8 | P | C | 1.5 | E |
| | 11 | 10 | 30 | 1.5 | 10 | 30 | 120 | 0.3 | P | A | 0.7 | G |
| | 12 | 10 | 30 | 1.5 | 10 | 100 | 120 | 0.8 | P | C | 1.1 | E |
| | 13 | 10 | 30 | 1.5 | 10 | 200 | 120 | 1.7 | F | D | 4.0 | E |
| | 14 | 1 | 27 | 2 | 3 | 20 | 30 | 0.7 | P | B | 0.5 | G |
| | 15 | 1 | 27 | 2 | 3 | 100 | 30 | 3.3 | F | D | 0.7 | E |
| | 16 | 80 | 27 | 135 | 3 | 20 | 30 | 0.7 | P | B | 2.1 | P |
| | 17 | 80 | 27 | 135 | 3 | 100 | 30 | 3.3 | F | D | 0.9 | P |

Various changes and modifications are possible in the present invention and may be understood to be within the present invention.

What is claimed is:

1. A porous material production method comprising the steps of:
(A) applying a solution containing a polymer and a hydrophobic solvent to a surface of a base material;
(B) causing dewetting of said solution on said surface;
(C) generating water drops on a liquid surface of said solution;
(D) evaporating said hydrophobic solvent from said solution on said surface to form a primary form into which said water drops enter; and
(E) evaporating said water drops from said primary form to form pores in said primary form, said pores being made by said water drops as a template for said porous material.

2. A porous material production method as defined in claim 1, wherein a coating thickness of said solution is a critical thickness at which the dewetting of said solution starts on said surface or less in the step A.

3. A porous material production method as defined in claim 1, wherein
a coating thickness of said solution is thicker than a critical thickness at which the dewetting of said solution starts on said surface in the step A; and
said hydrophobic solvent is evaporated from said solution until the coating thickness of said solution becomes said critical thickness or less in the step B.

4. A porous material production method as defined in claim 3, wherein the step B is performed before the step C.

5. A porous material production method as defined in claim 3, wherein the step B is performed after the step C.

6. A porous material production method as defined in claim 1, wherein a contact angle of said solution to said surface is at least 5°.

7. A porous material production method as defined in claim 1, wherein said surface is subjected to a surface treatment before the step A such that a contact angle of said solution to said surface becomes at least 5°.
